(19) United States
(12) Patent Application Publication
(10) Pub. No.: US 2024/0046558 A1
(43) Pub. Date: Feb. 8, 2024

(54) Wearable Display System Comprising Virtual Viewing Zone

(71) Applicant: Ostendo Technologies, Inc., Carlsbad, CA (US)

(72) Inventor: Hussein S. El-Ghoroury, Carlsbad, CA (US)

(21) Appl. No.: 18/231,717

(22) Filed: Aug. 8, 2023

Related U.S. Application Data
(60) Provisional application No. 63/396,037, filed on Aug. 8, 2022.

(51) Int. Cl. G06T 17/00; G02B 27/01

(52) U.S. Cl. CPC G06T 17/00; G02B 27/0172; G02B 2027/0178

(57) ABSTRACT

Wearable display to simultaneously connect with a virtual command and control center (VCC) dashboard display as well as one or more computing platforms to provide access to real-time visual sensory data or a light field cloud processor that may be configured to host digital-twin models of multiple operating zones within an overall system.

### CROSS-REFERENCE TO RELATED APPLICATIONS

This non-provisional application claims the benefit under 35 U.S.C. § 119(e) of U.S. Provisional Patent Application No. 63/396,037 filed Aug. 8, 2022, entitled “Wearable Display System Comprising Virtual Viewing Zone”, the entire contents of which are incorporated herein by reference. This non-provisional application is related to U.S. Nonprovisional application Ser. No. 16/994,574 filed Aug. 15, 2020, entitled “Wearable Display System and Design Methods Thereof”, the entire contents of which are incorporated herein by reference, U.S. Nonprovisional application Ser. No. 17/552,332, filed Dec. 15, 2021, entitled “Wearable Display System and Design Methods Thereof”, the entire contents of which are incorporated herein by reference, and U.S. Nonprovisional application Ser. No. 17/531,625 filed Nov. 19, 2021, entitled “Wearable Display Device and Visual Access Operating System Thereof”, the entire contents of which are incorporated herein by reference.

### BACKGROUND OF THE INVENTION

Applicant herein, Ostendo Technologies, Inc., has developed a novel Quantum Photonic Imager (QPI®) emissive micro-LED display technology that provides several advantages over current display technologies. These advantages enable a wearable display system platform that features the capabilities of the QPI® to provide a wearable display with key augmented reality (AR) features to give immersive and volumetric visual information access to a user with wearability and connectivity added that enable mobility and access to the user's ambient reality.

Various wearability, connectivity and visual operating system features of Applicant's wearable display technology and optical see through (“OST”) wearable display products enable the transfer of real-time visual sensor and control (meta) data to be used to virtually access and be immersed in massive visual 3D data, herein referred to as a light field, that is either generated from visual models, such as a “digital-twin” model, or from deployed sensors or a combination thereof.

The connectivity and visual operating system (vuOS™) capabilities of Applicant's wearable display technology products, as described in U.S. Nonprovisional application Ser. No. 17/531,625 filed Nov. 19, 2021, entitled “Wearable Display Device and Visual Access Operating System Thereof”, are designed to provide a light field cloud processor with the control data needed to permit a viewer to navigate and browse virtually across massive light field data in real-time with minimal processing and memory burdens that enable Applicant's AR display (OST wearable product) to be light weight and volumetrically efficient to provide a truly wearable AR display. Applicant's novel visual operating system (vuOS™) enables a user to be connected and simultaneously accept real-time visual data from multiple connected computing platforms.

For example, such features enable a wearable display to simultaneously connect with a virtual command and control center (VCC) dashboard display as well as one or more computing platforms to provide access to real-time visual sensory data or a light field cloud processor that may be configured to host digital-twin models of multiple operating zones within an overall system.

The following underlined terms, shall, without limitation, have the following meanings throughout this application:

Augmented Reality (AR): A head-mounted display technology that enables immersive and volumetric visual information access by a user.

AR Wearable Display: With wearability added, enables mobility and access to users' ambient reality.

Avatar: An icon or a computer-generated image (CGI) or figure representing a particular person in computer animation programs, internet forums, etc. A conversation with an avatar is often depicted using a “balloon” over the avatar's head.

Digital Twin: A virtual digital representation or model that serves as a real-time digital counterpart of a user-defined person, physical object, process, or system.

Edge Computing: Computing applications that run at the edge of a connectivity network close to where such data is processed, or where an action is triggered to reduce latency.

Graphic Processing Unit (GPU): A specialized parallel computer which is generally more efficient than a general-purpose central processing unit (CPU) especially for use with algorithms that process large blocks of data in parallel, such as computer graphics and image processing and rendering.

Integrated Displays: A plurality of displays having an integrated command structure and capabilities that enable complementary display of visual data; for example, a high-level or far-field view being displayed by a direct view large screen display used to guide the selection of a close-in or near-field view displayed on a wearable AR display.

Latency: The visual data turn-around time in response to the meta (control) data received from a virtual viewer's wearable display.

Light Field Display: A class of direct view displays that enable perception of three-dimensional or 3D information without the use of stereoscopic glasses or the discomfort of the vergence accommodation conflict (VAC) common when viewing conventional stereoscopic 3D displays.

Router: A device for the coupling of data in and out of a digital network; for example, internet, Ethernet, Wi-Fi . . . etc., in accordance with a specified network interface protocol.

Router/Server: A device for the coupling of data in and out of a digital network that performs digital data processing on the input/output data before routing the data to an end-use device.

Visual Capture Zone: The visual range covered by one or more capture cameras deployed in a monitoring zone.

Virtual Viewers: Users which are remotely located from a visual capture zone and use an AR wearable display to be virtually present, roaming or browsing within a visual capture zone.

### BRIEF DESCRIPTION OF THE DRAWINGS

FIG. 1 is a depiction of the visual capture zone coverage area of the invention using five 360° cameras.

FIG. 2 is an illustration of an exemplar architectural configuration of the invention.

FIG. 3 is an illustration of wireless connectivity of remote virtual viewers' wearable displays.

FIG. 4A is a first exemplar wearable display isometric view.

FIG. 4B is a first exemplar wearable display exploded view.

FIG. 5A is a second, alternative exemplar wearable display isometric view.

FIG. 5B is a second, alternative exemplar wearable display exploded view.

FIG. 6 depicts a wearable display system context and network nodes.

FIG. 7 shows an exemplar VeeaHub™ connectivity and computing node.

FIG. 8 shows the exemplar VeeaHub™ edge-computing visual analytics capabilities.

FIG. 9 depicts an exemplar visual capture node in the form of an Insta 360 Pro2 Camera.

FIG. 10 depicts an exemplar visual capture node in the form of a Katai 360° Camera.

The invention and various of its embodiments are set forth in the following description of the preferred embodiments which are presented as illustrated examples of the invention in the subsequent claims. It is expressly noted that the invention as defined by such claims may be broader than the illustrated embodiments described below.

### DESCRIPTION OF EMBODIMENTS

Turning to the description and the various figures wherein like references denote like elements among the several views, disclosed is a wearable display system comprising virtual viewing zone.

The disclosed device, method and system provides real-time streaming of 360° visual light field data to a wearable AR display to enable full mobility, visual immersion, simultaneous connectivity, and visual data access to a multiplicity of different computing platforms.

An exemplar use-case in the field of urban security monitoring may comprise a virtual command and control (VCC) system connected to one or more visual sensor arrays via a multiplicity of computing and communication assets that are configured to enable viewing (or monitoring) by one or more users that may be co-located at a VCC site or at one or more remote sites.

In this example, the VCC system model's designated monitoring area tracks the data sources (i.e., the outputs of one or more visual sensor arrays) in real-time and enables an immersive 3D virtual walkthrough of the monitoring area (zone). An advantage of incorporating an AR wearable display system in the exemplar VCC system setting is increased efficiency and responsiveness. These advantages may be realized using Applicant's AR wearable display system providing virtually immersive and volumetric visual information access within the context of a distributed wide area VCC system. With such capabilities it is possible to operate a highly efficient and responsive VCC system with a minimal number of security personnel and with added operational safety.

An exemplar configuration of the instant invention may comprise a VCC system monitoring zone (area) equipped with multiple 360° cameras, each connected to a wireless router that relays, in real-time, each of the 360° cameras' visual data outputs to a remote site that emulates the VCC system operational center or remote site. The relayed 360° camera visual data is received at the VCC system site by a router/server node that acts to coordinate access by multiple virtual viewers who may be co-located at the VCC site or at other remote sites to the relayed 360° camera visual data in real-time. The data processing performed by the router/server at the VCC site enables one or more virtual viewers at the VCC to roam, virtually, within the monitoring area while being aware of the presence and position of all the other virtual viewers within the monitoring area. This capability may be enabled through the inclusion of computer-generated images (CGI) or avatars representing the virtual viewers that allows virtual viewers, either co-located at the VCC site or at remote sites, to be aware of each other's presence within the monitoring zone, and to interact, communicate and coordinate their operational activities.

Within this context, the VCC system may comprise a dashboard for viewing by the viewers located at the VCC site. The VCC dashboard may be comprised of a multiplicity of, for instance, three, large screen displays connected to the visual sensor arrays via the VCC site router/server node to display a 3D digital replica (or digital twin model) of the monitoring zone or a designated monitoring area within the monitoring zone that enables the VCC dashboard viewer to capture a bird's eye view of the monitoring zone or a predetermined monitoring area.

In addition, the VCC router/server node may visually synchronize the sensor array's (360° camera array) visual output data from the monitoring zone with a digital twin model of the monitoring zone to enable a realistic perspective by the virtual viewer of the relayed (or sensed) visual data within the context of the monitoring area spatial details.

In an alternative embodiment, the VCC site router/server node may use the 360° camera array output to compute a full 3-D light field of the monitoring zone, and then overlay the computed light field and then spatially synchronize it with the digital twin (light field) model of the monitoring zone to fill-in static details. The synchronized 3-D light field, containing the 360° camera array captured visual data combined (merged) with the digital twin model, may be compressed to facilitate real-time transfer, and displayed at the VCC dashboard display as a 3D light field to be viewed by the virtual viewers at the VCC site from multiple perspectives. As determined from the sensory data received from the virtual viewers' wearable displays, the segment of the constituted light field within the virtual viewers' field of view (FOV), in compressed format, may be streamed in real-time to the virtual viewers' wearable display units.

The 3D light field of the monitoring zone that is displayed by the dashboard light field display (LFD) may be “visually integrated” with the virtual viewers' wearable display units to enable virtual viewers to zoom in or out, using their wearable display for near-field fine detail perspective, from a selected point of choice within the far-field perspective displayed by the dashboard LFD.

The dashboard light field cloud processor may be comprised a multiple graphic processing units (GPUs) operating as a parallel processing cluster with sufficient processing throughput and memory to enable the operational demands of multiple VCC sites that may be connected operationally to multiple monitoring zones.

Virtual viewers roaming and browsing within the monitoring area can select visual data (image clipping or snapshots) of subjects-of-interest and to dispatch the selected data relative to the subject-of-interest to an identification and recognition server that may be connected to the router/server at the remote site.

The instant invention emulates a VCC system visual monitoring area and necessary connectivity elements to the VCC remote site, co-located with, or remote from the VCC, where virtual viewers may virtually roam or browse within the emulated VCC system monitoring zone.

An exemplar system of the invention may be comprised of the following architectural elements:
a. Visual capture nodes and capture zone,
b. Data connectivity and computing nodes,
c. One or more wearable displays, and,
d. A VCC dashboard display.

### Visual Capture Node and Capture Zone

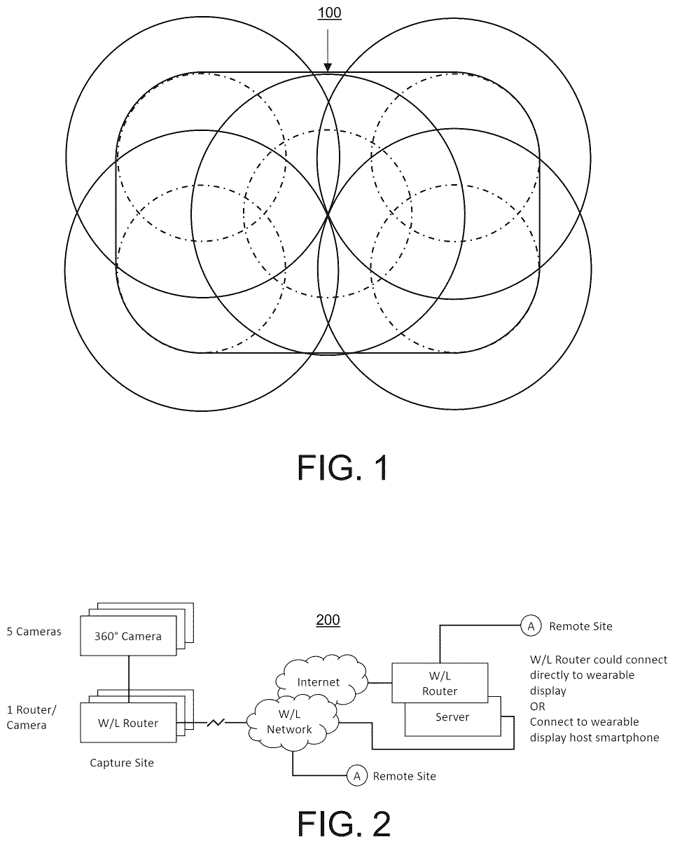

As illustrated in FIG. 1, the exemplar VCC system monitoring area and capture zone 100 is realized using multiple 360° cameras with overlapping image capture coverage. Each camera coordinates within the capture zone are known a priori. Center camera coordinates may be used as the capture zone reference coordinates. The overall area of the capture zone may be defined by the combined coverage of the multiple 360° cameras. In a preferred embodiment, the relative placement of the multiple 360° cameras is such that each point within the overall capture zone capture zone is covered by at least one of the multiple 360° cameras that define the overall capture zone.

As illustrated in FIG. 1, the overall capture zone for the exemplar system is defined by five 360° cameras, with one 360° camera located at the center of the capture zone area plus four 360° cameras located at the four corners of the exemplar capture zone area. To realize 360° capture coverage, each of the 360° cameras may be comprised of eight individual cameras, each having 45° field of view (FOV) coverage. In total, therefore, the exemplar capture zone is covered by forty (40) individual cameras, each having a 45° horizontal field of view (FOV). With the exemplar 360° capture coverage, any point within the capture zone illustrated in FIG. 1 is covered by at least two of the individual camera elements of the five 360° cameras defining the overall capture zone.

The placement distance between the 360° cameras may be determined by how much resolution is required at the boundaries of the camera coverage. Assuming a desire to resolve the facial features from an image of a person captured by the cameras, the 360° cameras may be placed about 10 meters apart. With such a benchmark, the area of the image capture zone illustrated in FIG. 1 is representative of about 40×60 meters. A larger area of the image capture zone may use additional 360° cameras.

Each of the exemplar five 360° cameras defining the overall capture zone may include the capability of Wi-Fi wireless and Ethernet connectivity at 8K pixels. Each of the five 360° cameras defining the overall capture zone may include appropriate computing resources, both hardware and software, configured to stitch the captured video from the individual camera elements in the illustrated scenario and then output the stitched video at 8K pixels in real-time to its associated connectivity element, via either Bluetooth, Wi-Fi or wired Ethernet.

### Data Connectivity and Computing Nodes

In one embodiment, each of the 360° cameras (or capture nodes) defining the capture zone illustrated in FIG. 1 is connected to a wireless router that relays, in real-time, the 360° camera visual data outputs to the remote site(s), including the VCC site. Each capture node operates autonomously in terms of fulfilling its operational role of 360° visual data capture. Nonetheless, the connectivity and computing nodes of the illustrated system may be provided with additional processing capability to perform selected image enhancements, such as digital zoom or magnification, image clipping of specified portion of the captured imagery data, contrast/color enhancement, shadow filtering, etc.

The connectivity and computing assets at the capture node relay the captured imagery data to the connectivity and computing assets at the VCC site and other remote site(s) via the wireless network and the internet. The connectivity and computing assets at VCC site and other remote site(s) also receive control (or meta) data from the virtual viewers' wearable displays, routed via their host wireless computing devices, for example, a smartphone, laptop, or desktop computer.

The control data received from the virtual viewers' wearable displays is processed by the connectivity and computing assets at the VCC remote site and is used to identify the segment of the imagery data received from the capture zone needed to be routed to each virtual viewer's wearable display device. The meta (control) data received from the virtual viewers' wearable display devices is also used to process and respond to a virtual users' request for image processing features such as selecting visual data (image clipping or snapshots) of subjects-of-interest within the received imagery data and requesting a dispatch of the selected data for the subject-of-interest to an identification and recognition server that may be connected to the router/server at the remote site.

The connectivity and computing assets may be co-located with the VCC and directly connected to the VCC dashboard display system. The VCC dashboard may comprise multiple, large screen displays. The processing capabilities of the router/server connected to the VCC dashboard displays blend the live visual output streamed from the 360° cameras with digital twin visual 3D model data of the monitoring zone, or a specific area of the monitoring zone selected by the virtual users, to enable the display of a high-level perspective (or view) of the selected monitoring area available for viewing by the virtual viewers.

The processing capabilities of the router/server connected to the VCC dashboard may be provided to correlate the sensory control data received from the virtual users, then provide a zoomed-in view of the monitoring area that the virtual user is focused on. In this embodiment, the processing capabilities of the router/server connected to the VCC dashboard may be configured to correlate the virtual user's gaze (or perspective) direction with the monitoring area digital twin model, then route the corresponding display field of view (FOV) segment of the digital twin model visual data to the virtual user's wearable display for viewing.

This capability is referred to as an “integrated display” since the capabilities and the command structure of the two displays; namely, the dashboard display and the virtual viewer's wearable display, are integrated to enable the virtual viewer to use the dashboard display far-field view to navigate within the monitoring zone, then zoom-in to view higher level of details, or a near-field view, of an area of interest using the virtual user's wearable display.

### Wearable Displays

The roaming and browsing within the capture zone by virtual viewers, either co-located at the VCC site or at other remote site(s), are accomplished by the wearable display worn by the virtual viewers (or participants) at the sites. The wearable display worn by the virtual viewers at these sites receives selected imagery data from the capture zone, which is based on meta (control) data generated and sent to the connectivity and computing assets at the site. The wearable display then displays the received imagery data to the virtual viewers in a manner that virtually immerses the viewer within the capture zone. The meta data that a virtual viewers' wearable display device relays to the connectivity and computing assets at the remote site may comprise sensory data that indicates the virtual viewer's position and perspective (viewing or gaze direction) within the capture zone. The meta data that a virtual viewers' wearable display device relays to the connectivity and computing assets at the virtual viewing site may also comprise imagery data service requests generated by the virtual viewers.

The virtual viewer's viewing angle is referred to herein as the “virtual viewer perspective” or look or gaze direction. A description of how the virtual viewers' perspective, or viewing angle, is resolved is provided herein. The meta data that the virtual viewers' wearable display device relays to the connectivity and computing assets at the remote site includes sensory data that indicates the virtual viewer's position and perspective (viewing direction) within the capture zone. The virtual viewer's wearable display is connected wirelessly to the viewer's smartphone or mobile device such that the virtual viewer emulates their virtual roaming of the capture zone by physically moving around within the remote site (or the virtual commend center, VCC) at, for example a 1:1 scale.

The viewer's physical movement is detected by one or more position and/or orientation sensors on the wearable display and sent, as meta data, to the connectivity and computing assets at the VCC site or other remote site(s). The differential changes in the virtual viewer's position and perspective (viewing direction) are computed and updated in real-time and used by the connectivity and computing assets at the VCC site or other remote site(s) to compute the segment of the visual imagery data received from the capture site camera array sent to a virtual viewer's wearable display device, in real-time. With the disclosed sensory and visual imagery data closed-loop approach, a virtual viewer has the sensation of being present at the capture site and becomes virtually aware of what is occurring at the capture site. Based on the feedback meta (control) data from the virtual viewer's wearable displays, the visual data is updated, in real-time based on their respective virtual locations within the visual capture zone.

In addition, when the virtual viewer's viewing segment is calculated, it may incorporate one or more of the avatars of other virtual viewers present in that segment of the monitoring zone. With this feedback loop capability, the virtual viewers can see the avatars of other virtual viewers roaming within the visual capture zone, thus becoming aware of all other virtual viewers' positions and perspectives.

The virtual viewers that are co-located at the VCC site or other remote site(s) are made aware of the presence and position of other virtual viewers roaming and browsing within the capture zone. This is accomplished when the virtual viewers' position and perspective (viewing direction) within the capture zone is computed by the connectivity and computing assets at the remote site based on the sensory information generated by the virtual viewers' wearable display devices. Based on the computed virtual viewers' position and perspective within the capture zone, the connectivity and computing assets at the VCC remote site inserts within the imagery data it received from the capture zone, a computer-generated image (CGI) avatar representation of each virtual viewer.

When the computed virtual viewers' position and perspective (viewing direction) within the capture zone includes other virtual viewers' CGI avatars, the virtual viewer becomes virtually aware of the presence and position of other virtual viewers relative to their own position as computed by the connectivity and computing assets at the remote site.

The CGI avatars inserted into the capture visual data stream by the connectivity and computing assets at the VCC remote site may be selectable from a multiplicity of generic avatar models stored at the VCC computing assets node. Virtual viewers, using their wearable displays or the VCC dashboard display, are thus able to edit their selected generic avatar CGI to add customization features from a set of customization features library located at the VCC connectivity and computing assets node and accessible using either the virtual viewers' wearable displays or the VCC dashboard display.

As intended herein, the added avatars are meant to be digital representations of the virtual viewers roaming and browsing virtually within the monitoring zone while actually being co-located at the VCC site or another remote site. The communication between avatars means communication between virtual viewers who are roaming and browsing within the capture or monitoring zone. This capability may be enabled through the “visual context switching” feature of Applicant's OST-4 Wearable Display Visual Operating System (vuOS™) as further described in U.S. Nonprovisional application Ser. No. 16/994,574 filed Aug. 15, 2020, entitled “Wearable Display System and Design Methods Thereof”, and U.S. Nonprovisional application Ser. No. 17/552,332, filed Dec. 15, 2021, entitled “Wearable Display System and Design Methods Thereof”.

With this capability, the users of the OST-4 Wearable Display, i.e., the virtual viewers at the VCC site or other remote site(s), can assign different field-of-view (FOV) slots of their OST-4 Wearable Display to different avatars as well as their own. In one embodiment, when virtual viewers' avatars communicate, it may be accomplished using visual context switching through the Wearable Display vuOS™ between the FOV visual slots assigned to the communicating avatars. To explain further, the virtual user may assign a default FOV visual slot of their wearable display to their own avatar, and in so doing, the virtual viewer sees what their avatar sees, so to speak. The virtual user may also assign a different FOV visual slot to an avatar they wish their avatar to communicate with to enable the virtual viewer to also see what the avatar they wish to communicate with sees. Visual context switching through their Wearable Display vuOS™ between these two different FOV visual slots enables the two avatars to communicate.

The Wearable Display vuOS™ enables visual context switching between differently assigned FOV slots using one of multiple command modes, including, sensed viewer head movement, voice command, touch command or gesture command. When the FOV of another preset avatar is selected by the virtual viewers, using their wearable display vuOS™ commands, the virtual viewer's avatar and the selected other avatar can communicate either by texting, which will be displayed below the communicating virtual viewer's avatar image or in a balloon over the avatar's head, or by audio connection between the communicating avatars.

The virtual viewer's wearable display is connected wirelessly to the viewer's smartphone so that the virtual viewer emulates their virtual roaming in the capture zone by physically moving within the VCC or other remote sites. The virtual viewer's movements are sensed at 1:1 scale relative to the monitoring zone dimensions or any other virtual user-selected scale. The viewer's physical movement is detected by one or more position and orientation sensors on the wearable display and sent, as meta data, to the connectivity and computing assets at the remote site.

The differential changes in the virtual viewer's position and perspective are computed and updated in real-time and used by the connectivity and computing assets at the remote site to compute the segment of the visual imagery data it receives from the capture site that is sent to the virtual viewer's wearable display device, in real-time. With this sensory and visual imagery data closed-loop approach, the virtual viewer is provided with the sensation of being present at the capture site and becomes virtually aware of what is occurring at the capture site.

The virtual viewer's position (location) within the monitoring zone is updated by the VCC router/server node in real-time to enable the virtual viewer to determine at a glance their location within the monitoring zone by simply viewing their host computing platform (e.g., smartphone or tablet). This means the virtual viewers are kept aware in real-time of the location of their avatars within the monitoring zone, in addition to being aware of the position of the other virtual viewers' avatars. Using their avatars' position real-time updates, the virtual viewers can reset their avatar position to any position within the monitoring zone.

Upon the virtual viewer's reset of their avatar location, the VCC router/server resets the virtual viewer's avatar position and updates the avatar trajectory in real-time thereafter. This capability is in effect equivalent to the virtual viewer being able to instantly “jump’ from on location to another within the monitoring zone or may be provided to allow virtual viewers to jump from one monitoring area to another.

### The VCC Dashboard Display

The VCC system comprises a dashboard that can be viewed and interacted with by viewers co-located at the VCC site. The VCC dashboard may be comprised of a multiplicity of large screen displays that are in communication with the visual camera array via the VCC site router/server node to enable the display of visual information for any selected live feed camera within the array of cameras deployed in the monitoring zone. The VCC dashboard displays may be equipped with an interactive touch screen driven by a display command menu to enable the virtual viewers co-located at the VCC to: (1) create viewing sub-screens to display selected visual or command information; and (2) be able to select a specific live feed camera output to be displayed in real-time (live video stream) on the dashboard screen or created sub-screen. It should be noted that the virtual viewer's wearable display has an unobstructed see-through capability across its full optical aperture that allows the virtual viewer to view the dashboard display screen or selected sub-screen. The term “integrated” is defined to mean that the visual information routed to the virtual viewer's wearable display is coordinated with the dashboard touch screen commands and may be selected to either be the displayed content of the dashboard screen or sub-screen or to be a more detailed version of the dashboard screen or sub-screen.

With such an “integrated” command structure between the dashboard touch screen and the virtual viewer's wearable display, the dashboard visual information can be “coarse”, far-field or a bird's eye view that can be zoomed in for more a detailed near-field view, then displayed on the virtual viewer's wearable display, or zoomed back out into a coarse format of the bird's eye view displayed on the dashboard screen or sub-screen.

This capability is made possible by integrating the command structure of both the VCC dashboard display and the virtual viewers' wearable displays into a common command structure that implements at the router/server node co-located at the VCC site. With such an integrated display command structure, the virtual viewers that are co-located with the dashboard display at the VCC site are able to interact with the dashboard display to zoom in and zoom out of the monitoring zone as operationally required.

With these integrated display command structures, the virtual viewers co-located at the VCC site are able to visualize and have an accurate perspective of the monitoring zone by transitioning from the bird's eye coarse perspective of the 3D digital twin model displayed on the VCC dashboard display to a finer detail 1:1 scale perspective by viewing the live visual data streamed from the 360° camera array through their wearable displays. This is yet another aspect of the integrated command structure of the VCC dashboard displays, and the virtual viewer's wearable displays that provides virtual viewers with coordinated interaction and transition capabilities for selecting coarse (far-field) perspective displayed on the VCC dashboards to fine (near-field) perspective viewed on their wearable displays.

In a further operational mode of the VCC dashboard, the displayed visual information may be a 3D digital replica (or digital twin model) of the monitoring zone or a designated monitoring area within the monitoring zone that enables the VCC dashboard viewers to capture a bird's eye view of the monitoring zone or a designated monitoring area's geometric and topological aspects. When the digital twin model and the live feed (360° camera array) visual information are combined (merged) together, the added visual texture (or detailed context) enable the virtual viewers to perceive the visual information relayed (captured) from the monitoring zone. The VCC site router/server node visually blends and synchronizes the sensor array (360° camera array) visual output data with the monitoring zone digital twin model to enable realistic perspective (high texture) by the virtual viewers of the relayed (or sensed) visual data within the context of the monitoring area's spatial details.

The virtual viewer's position (location) within the monitoring zone is updated by the VCC router/server node in real-time to enable the virtual viewer to determine at a glance their location within the monitoring zone by simply viewing their host computing platform (smartphone or tablet). Using the VCC dashboard display, the virtual viewers are kept aware in real-time of the location of their avatars within the monitoring zone. The virtual viewers can, via the dashboard touch screen commands, see their own avatar's location within the monitoring area composite digital twin and live feed visual scene to gain a full preceptive of their location within the monitoring area. This capability allows the virtual viewers to make their avatars “jump” across the monitoring area from one position to another.

Using the combination of a wearable display and the VCC dashboard display, virtual viewers co-located at the VCC site can, through active touch screen interaction with the dashboard display, create their own avatars and position these avatars anywhere within the monitoring area. Also using the combination of a wearable display and the VCC dashboard display of the invention, the virtual viewers are able to plan security operations through interaction, via the dashboard active touch screen, with the monitoring area digital twin model by sketching their plans directly on the digital twin model displayed on the dashboard screen or sub-screen.

Using the combination of interactions with the VCC dashboard display and their wearable displays, the virtual viewers can select their position within the monitoring zone, considering the geometrical and topological details provided by the digital twin 3D model, then using their wearable display to virtually roam and browse through the monitoring area at a 1:1 scale walkthrough.

### Configuration (Block Diagram)

FIG. 2 illustrates a block diagram 200 of the invention of the disclosure. In the earlier exemplar system, five 360° cameras may define the visual capture zone (see FIG. 1). The coordinates of each of the five 360° cameras within the visual capture zone are fixed and known a priori to the remote site server/router at the VCC and the center 360° cameras coordinates are used as the reference coordinates for the entire capture zone area. Any one of the remote sites may be co-located with the virtual command and control center (VCC).

A wireless (W/L) router is preferably physically placed in the vicinity of each of the five 360° cameras defining the visual capture zone area. In a preferred embodiment, a single W/L router is configured to support multiple WiFi links simultaneously to support the connectivity of multiple cameras. In the configuration illustrated in FIG. 2, the W/L routers associated with the five 360° cameras serve to route the stitched video outputs from each of the five 360° cameras, wirelessly, to the remote site at the VCC via their connectivity interface ports through the W/L network and the internet (see FIG. 2).

As illustrated in FIG. 2, the W/L connection from the cameras' routers may be through a mobile network (preferably 5G). The captured visual data from the 360° cameras is then routed to the remote site(s), the VCC site or other sites, either through the internet or directly through the mobile W/L connectivity that could be provided by the W/L router(s) supporting the interface at the visual capture zone area.

A router/server is physically placed in the vicinity of at least one of the remote sites where a virtual viewer will be located, for example at the VCC. As illustrated in FIG. 2, virtual viewers may be co-located in proximity to the remote site router/server is located near the VCC site, or they may be in other areas that are supported with wireless mobile network or WiFi connectivity with the remote router/server.

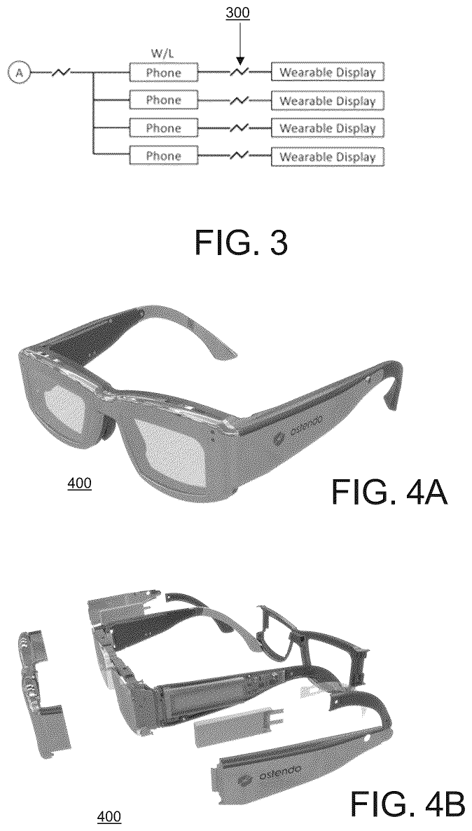

FIG. 3 illustrates the remote site router/server wireless connectivity 300 with the virtual viewers' wearable display devices in both cases. When the virtual users are co-located with a router/server, their wearable display connectivity may be supported by a WiFi link interface provided by the router/server. In a further embodiment, when the router/server at the remote site is provided with mini-mobile network interface capabilities, that such mini-mobile network wireless links are used to connect the virtual viewers' wearable displays to the remote site router/server.

In both cases, the virtual viewers' wearable connectivity is supported through their mobile smartphones' WiFi or mobile wireless link interface capabilities. Both operational modes for supporting the wireless interface between the remote site router/server and the virtual viewers' wearable display devices are illustrated in FIG. 3.

It should be noted that FIG. 3 and FIGS. 4A and 4B together illustrate operational modes when the virtual viewers are physically co-located with the remote site router/server at the VCC site and the case when the virtual viewers are not physically co-located with the remote site router/server at the VCC site. The difference between these two operational modes is added latency of the connectivity through the wireless mobile network from the remote site router/server to the virtual viewers' smartphone which may serve as the computing host or processing resource for the wearable display.

Feedback meta (control) data from the virtual viewers' wearable displays, through their host smartphone wireless link(s), may include the virtual viewers' position coordinates within the (virtual) capture zone and their perspective vectors relative to the reference coordinates of the visual capture zone supplied by the VCC remote site W/L router server. The feedback meta (control) data from the virtual viewers' wearable displays is used by the VCC remote site router/server to:
1. Compute the virtual viewer's position within the multiple 360° cameras' coverage and identify the visual video stream, which represents each of the virtual viewer's perspective, then route the identified visual video stream to the virtual viewers' wearable display via their smartphone, and:
2. Insert, within the visual video streams routed to the virtual viewers, a CGI representation (or an avatar) of virtual viewers located within those visual coverage segments of visual capture zone.

Using the feedback meta (control) data, the virtual viewers' wearable displays visual data is updated in real-time based on their virtual location within the visual capture zone and all the virtual viewers are able to see the avatars of other virtual viewers roaming within the visual capture zone, thus becoming aware of all other virtual viewers' positions and perspectives.

### Architectural Elements

Having described in the previous sections certain embodiments of the system architecture, capabilities and configurations of the invention, this section provides certain details of exemplar architectural elements specifications and capabilities.

### Wearable Display System

In a preferred embodiment, the wearability advantages of Applicant's wearable display are enabled by Applicant's Quantum Photonic Imager (QPI) device which is a state-of-the-art micro-LED display with a red/green/blue (RGB) micro-scale (10-micron or less) pixel pitch.

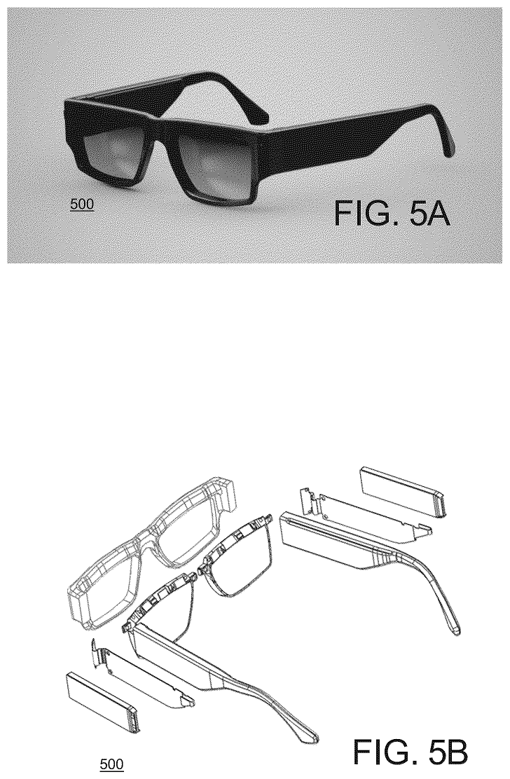

FIGS. 4A and 4B, and FIGS. 5A and 5B depict visual isometric and exploded views 400, 500, respectively, of Applicant's OST-3 and OST-4 wearable displays, each of which is well-suited for use in the instant invention.

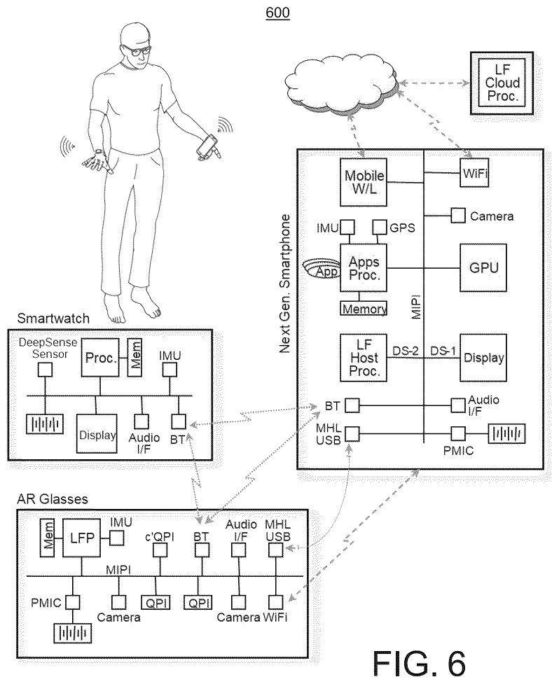

FIG. 6 illustrates Applicant's wearable display within the illustrated system architectural context 600 that is connected wirelessly via WiFi or Bluetooth to a host computing platform, which may be provided as a smartphone, laptop computer, desktop computer or any one of many computing platforms users typically encounter in their daily activities.

The wearable display operating environment may use a visual context switching operating system (vuOS™) to enable the wearable display to connect (or pair up) with any encountered computing platform. Through the wearable display connectivity with a host computing platform, the wearable display may be connected with a cloud processor configured to render the visual inputs from a multiplicity of sources to constitute (or render) a complete 3D light field of the venue from which the visual inputs are captured.

Either in real or subsequent time, wearable display users are able to browse, virtually, in the constituted light field. For instance, Applicant's light field streaming protocol streams segments of the constituted light field in which the virtual viewer is browsing based on feedback meta (control) data that the light field cloud processor receives from each connected wearable display.

In one aspect of the invention, the disclosed wearable display system context is envisioned to be realized across an entire city to enable virtual users' participation in urban security monitoring (USM), telemedicine systems, smart hospitals, education systems, virtual shopping centers, social networks, business systems and numerous other applications that involve connecting people to an extensive visual database or digital light field to enable a user to navigate and become immersed within information fields rather than looking at flat information segments from the outside using flat screen displays.

### Connectivity and Computing Nodes

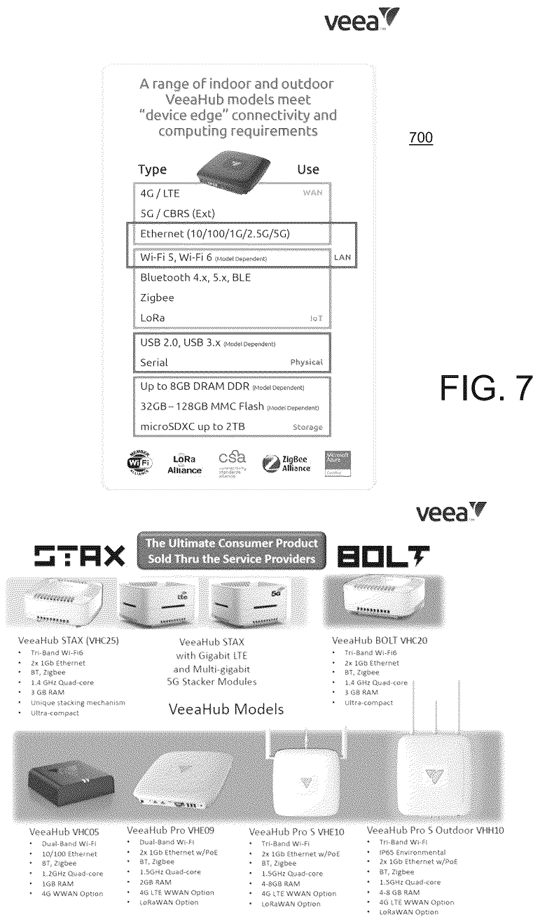

A suitable computing hub for use with the connectivity and computing nodes of the invention includes VeeaHub® available from Veea, Inc. to perform the router and router/server functions described above. The wireless and wired connectivity interface capabilities that can be provided by VeeaHub® are highlighted at 700 in FIG. 7.

As illustrated in FIG. 7, the VeeaHu® platform can fulfill broad range of wired and wireless interface capabilities to support connectivity interface requirements. In addition to the connectivity capabilities highlighted in FIG. 7, the VeeaHub® can support the remote site router/server function described above. The VeeaHub® provides a high-performance “computing platform” that efficiently runs a Linux operating system on a quad-core 64-bit CPU to enable software applications to run at the “edge” of the connectivity network close to where the data needs to be processed or an action needs to be triggered.

In addition to providing increased control and efficiency, the edge computing capabilities of the VeeaHub® enable low latency (the visual data turn-around time in response to the meta data received from the virtual viewers' wearable displays) since the visual data computation performed by the router/server node at the remote site, for example the VCC site, is close to where the virtual viewers are located. The Linux server function of the VeeaHub® is supported by up to 8 GB of memory and 32 GB of flash storage, making it capable of supporting the router/server visual data processing functions described above.

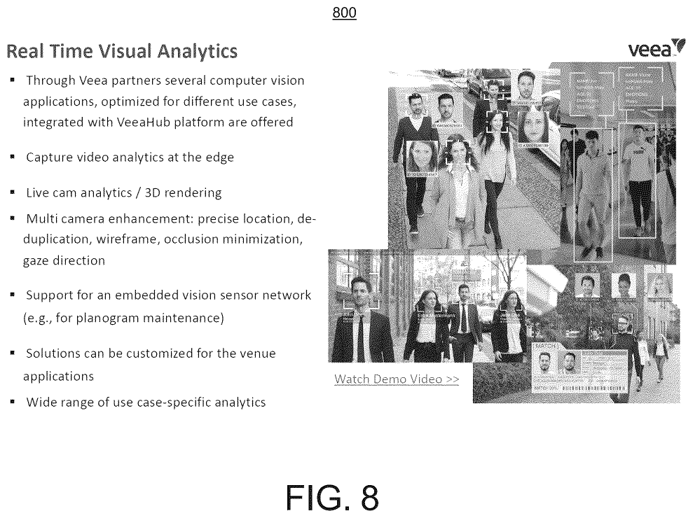

With its integrated wireless and wired connectivity and server-class edge computing capabilities, the VeeaHub® performs several of the server functions described above including the capture and analysis of visual analytics. This capability of the VeeaHub® is illustrated at 800 in FIG. 8 which shows an example of visual analytics software running on the VeeaHub® server to enable capture and analysis (recognition) of visual information included in the captured imagery data. Through the meta (control) data interface between the wearable display and its connected host computing platform, the virtual viewer is able to select snapshots of the displayed visual data to be dispatched for recognition and identification.

### Visual Capture 360° Camera Nodes

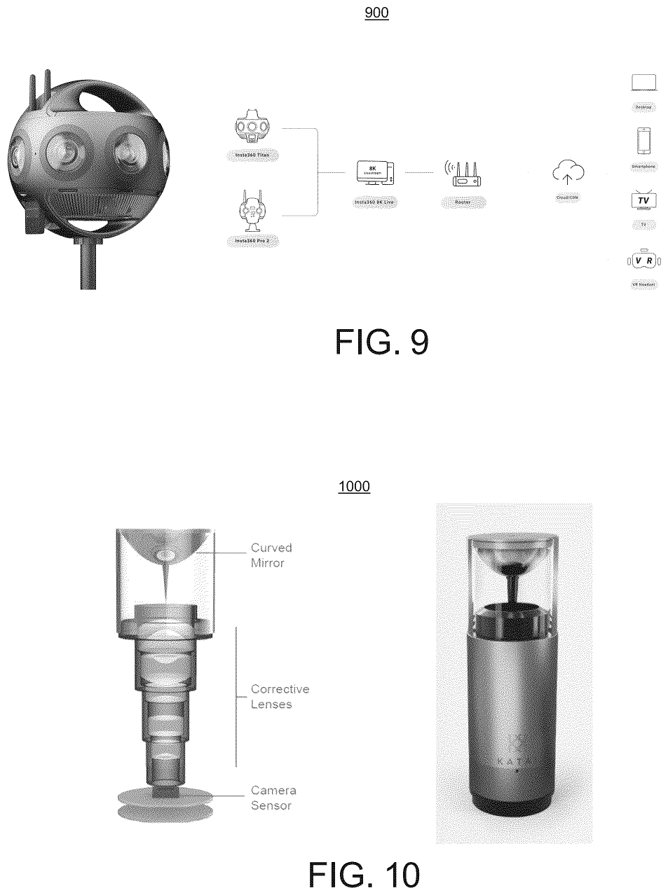

Several 360° camera candidates for the visual capture nodes have been evaluated and following provides an overview of the capabilities and advantages of two preferred models representing the current spectrum of 360 camera products presently available in the market. Representing the most common 360° camera technology 900 is the Insta 360 Pro2 camera presented in FIG. 9. Similar to other 360° cameras, the Insta 360 Pro2 camera is an assembly of eight 45° field of view (FOV) cameras with their imagery data (video) outputs digitally stitched to cover a 360° FOV using integrated software. The Insta 360 Pro2 camera provides 8K video output at 30 FPS via a variety of interfaces including Ethernet and WiFi.

Another class of 360° camera technology 1000 is the Katai camera presented in FIG. 10. Unlike typical 360° cameras that use software-based digital stitching of its multiple camera elements, the Katai camera 360° field of view (FOV) is captured and de-warped optically and does not require digital stitching. Besides its optical 360° horizontal FOV, the Katai camera has a 90° vertical FOV and outputs 48 megapixels video at 30 fps. The Katai 360° camera supports USB and HDMI real-time video streaming output interface as well as Ethernet, WiFi and Bluetooth interfaces. The physical characteristics of the Katai 360° camera are: height—130 mm; diameter—42 mm; and weight—173 grams, which makes it more compact and lightweight for easier mounting with the visual capture zone.

### Remote Viewer Access (Virtual Viewers)

The roaming and browsing within the capture zone by virtual viewers at the remote site(s), including the VCC site, enables users to become aware of activities at the visual capture zone. In addition, the virtual viewers are made aware of the presence and location, within the visual capture zone, of other virtual viewers. This capability is made possible by the meta (control) sensors data provided from the wearable display to the router/server compute node that may be co-located at the VCC site. The wearable display sensors data provided to the router/server of the virtual location of the virtual viewer within the visual capture zone is used by the compute function of the routers/server to compute the location and perspective of the virtual viewer within the visual capture zone.

To facilitate this capability, the virtual viewers may use the host computing platform, smartphone, laptop computer . . . etc., associated with their respective wearable display to mark their initial position and perspective (look direction) within the visual capture zone. After their position is initialized, virtual viewers' position within the visual capture zone is update or tracked by the remote site router/server based on the sensors' data updates provided by the virtual viewers' wearable display. With such a capability, virtual viewers can re-initialize their position at any subsequent time during their virtual viewing session to be virtually present, instantly, at any selected position and perspective within the visual capture zone.

Using the computed virtual viewers' position and perspective, the remote site router/server inserts into the captured visual imagery data, a CGI avatar representing the position and perspective of each virtual viewer roaming and browsing within the capture zone. With this capability, the visual imagery data routed to each virtual viewer, based on their tracked position and perspective, contains the avatars of other virtual viewers that are virtually present within their field of view (FOV). When it's assumed that the virtual viewers will be required to enter their identity during the logon sequence using the host computing platform, smartphone, laptop computer . . . etc., associated with their wearable display, it is possible the remote site router/server compute function may be configured to add an identification annotation below each inserted virtual viewers' avatar. This capability enables the virtual viewers not only to be aware of the presence, location and perspective of other virtual viewers that are roaming within the visual capture alone but also be aware of their identity as well.

### Recognition and Identification

At any time during their session, the host computing platform, smartphone, laptop computer . . . etc., associated with the virtual viewers' wearable display will show on the display screen the visual imagery data being displayed by the wearable display. Using the visual imagery data being displayed on the host computing platform screen, the virtual viewers can select a snapshot of a particular subject-of-interest within their field of view. Appropriate software operating on the host computing platform then clips the selected snapshot and sends it to the remote site router/server, which then dispatches the subject-of-interest snapshot for recognition and identification by a connected user-defined database (see FIG. 8).

This same capability is available to virtual viewers co-located at the VCC site using the VCC dashboard display. Using the visual imagery data being displayed on the VCC dashboard display screen, the virtual viewers can select, using the dashboard touch screen, a snapshot of a particular subject-of-interest within the displayed view. Appropriate software operating on the server computing node connected to the VCC dashboard display then clips the selected snapshot and dispatches it for recognition and identification by a connected user defined database.

### SOFTWARE CONFIGURATION

All application software may run on the server located at the remote site co-located at the virtual command center (VCC) site. The functions of the application software may include:
1. Running an interface protocol stack for receiving the streaming video data from the 360° camera array and indexing the received imagery data from each 360° camera based on each camera's location coordinates within the visual capture zone.
2. Running the interface protocol stack for receiving the control (meta) data from the virtual viewers wearable display units through their host computing platforms (smartphone or tablet), including:
   a. The sensory data indicating the virtual viewer's perspective (look direction); and;
   e. The virtual viewer's location within the visual capture zone calculated by their host computing platforms (smartphone or tablet).
   f. Correlating the control data received from the virtual viewers' wearable display units with the indexed imagery data received from the 360° camera array to parse it into a subset of imagery video data contained (or covered) within each of the set of virtual viewers' wearable display units' field of view (FOV).
4. Inserting the virtual viewers' avatars within the parsed subsets of imagery video data designated for the set of virtual viewers wearable display units' field of view (FOV).
5. Running the interface protocol stack for streaming the parsed video data, with the inserted avatars included, to the viewers' wearable display units via their host computing platforms (smartphone or tablet).

In one embodiment, the software runs on the wearable display unit's host computing platform (e.g., smartphone or tablet) that computes differential updates of the virtual viewers' position (location) within the visual capture zone and appends the calculated position updates within the control data (meta) that is sent from the virtual viewers' wearable display units to a server via their host computing platform (e.g., smartphone or tablet).

The API running the interface protocol stack between the virtual viewers' wearable display units and their host computing platform has already been developed and vetted in multiple test scenarios including live video streaming.

Various alternative embodiments may facilitate a user's viewing experience of the VCC system to become more realistic and precise, thus improving the overall system effectiveness and efficiency. Light field technology enables the viewing experience of the VCC system virtual viewers to become a truly fully focusable depth 3D visual experience.

This is achieved by taking advantage of the fact that the 360° camera array captures an expanded set of views across the monitoring area which, when complemented by the monitoring area digital twin 3D model, is sufficient when merged and processed by the light field cloud processor to constitute a true 3D data set.

Such a data set can be streamed, in real-time, to be displayed by the VCC dashboard light field display in a full surround 3D at the coarse perspective to be viewed by all the viewers co-located at VCC site, while simultaneously being displayed at the fine perspective, in a narrower FOV, to the virtual viewers by their wearable light field display. In this technology environment, these two tiers of light field displays, i.e., the VCC dashboard display and the virtual viewer's wearable AR displays, have a unified command structure to operate as an “integrated” display system. The interaction with such an integrated light field display system may be accomplished by use of a virtual viewer's wearable gesture sensor (see FIG. 6) to provide additional operational resilience, efficiency, and reliability.

Many alterations and modifications may be made by those having ordinary skill in the art without departing from the spirit and scope of the invention. Therefore, it must be understood that the illustrated embodiments have been set forth only for the purposes of example and that they should not be taken as limiting the invention as defined by any claims in any subsequent application including any application claiming priority to this application.

For example, notwithstanding the fact that the elements of such a claim may be set forth in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification, structure, material or acts beyond the scope of the commonly defined meanings. Thus, if an element can be understood in the context of this specification as including more than one meaning, then its use in a subsequent claim must be understood as being generic to all possible meanings supported by the specification and by the word itself.

The definitions of the words or elements of any claims in any subsequent application claiming priority to this application should be, therefore, defined to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements in such claims below or that a single element may be substituted for two or more elements in such a claim.

Although elements may be described above as acting in certain combinations and even subsequently claimed as such, it is to be expressly understood that one or more elements from a claimed combination can in some cases be excised from the combination and that such claimed combination may be directed to a sub-combination or variation of a sub-combination.

Insubstantial changes from any subsequently claimed subject matter as viewed by a person with ordinary skill in the art, now known or later devised, are expressly contemplated as being equivalently within the scope of such claims. Therefore, obvious substitutions now or later known to one with ordinary skill in the art are defined to be within the scope of the defined elements.

The following claims are thus to be understood to include what is specifically illustrated and described above, what is conceptually equivalent, what can be obviously substituted and what essentially incorporates the essential ideas of embodiments of the invention.

What is claimed is:

1. A display system, comprising:
a plurality of visual capture nodes with overlapping image capture coverage that define a visual capture zone;
a visual display center dashboard display,
communication means coupled to the plurality of visual capture nodes and the visual display center dashboard display to transmit visual data outputs of the visual capture nodes to the visual display center dashboard display; and
one or more wearable displays coupled in communication with the visual display center dashboard display to transmit control data to the visual display center dashboard display to identify a segment of the visual data outputs of the visual capture nodes to route to the wearable displays.
